(19) United States
(12) Patent Application Publication
(10) Pub. No.: US 2017/0325622 A1
(43) Pub. Date: Nov. 16, 2017

(54) DEVICE FOR PERFORATING A CAPSULE CONTAINING AN INFUSION PRODUCT

(71) Applicant: CMA MACCHINE PER CAFFE' S.R.L., Susegana, VT (IT)

(72) Inventors: Giovanni ROSSETTO, Susegana (IT); Alessandro COCCO, Susegana (IT)

(21) Appl. No.: 15/531,426

(22) PCT Filed: Dec. 1, 2015
(86) PCT No.: PCT/IB2015/059247

§ 371 Date: May 27, 2017

(30) Foreign Application Priority Data
Dec. 1, 2014 (IT) MI2014A002064

(51) Int. Cl. A47J 31/40; A23F 5/26; A47J 31/06; A47J 31/44

(52) U.S. Cl. CPC A47J 31/407; A47J 31/446; A23F 5/26; A47J 31/0642

(57) ABSTRACT

The device for perforating a capsule containing an infusion product comprises a support of a filter holder for automatic or semi-automatic coffee machines in which the capsule and a perforating element of the capsule contained in the seat of the filter holder are housed, the perforating element has a surface having circular shape having on a face thereof a plurality of spikes having a maximum reciprocal distance that is smaller than the diameter of the collar of the capsule such as to realize, on the aluminum closing film of the same capsule, a plurality of holes communicating with the infusion product.

### FIELD OF THE INVENTION

The present invention relates to a device for perforating a capsule containing an infusion product.

### KNOWN BACKGROUND ART

As known, so-called automatic or semiautomatic coffee machines using, to make the coffee beverage, infusion assemblies each provided with a filter holder in which the coffee powder is placed, are currently available on the market.

The coffee powder can get into the filter holder either from a grinder placed inside the machine or from a grinder outside the same.

In addition, on the market there are coffee machines of the household type without filter holder and using pods or sealed capsules containing a predetermined dose of coffee powder for delivering the coffee beverage.

Normally, in these machines, various systems automatically perforate the capsules while they are placed in the infusion chamber, thereby allowing pressure water to pass therethrough.

Currently, the capsules available on the market can not be used in an automatic or semiautomatic machine designed for ground coffee because, even if they can be introduced into the filter holder, there are no devices able to scientifically perforate them and to guarantee the optimal production of an excellent coffee having superior characteristics with respect to a coffee obtained with the machines of the household type.

In fact, the functions of an automatic or semi-automatic machine with respect to one of household type for obtaining an optimal coffee beverage, are indisputably superior.

### SUMMARY OF THE INVENTION

The aim of the present invention is to overcome the drawbacks of the prior art by providing a device for perforating a capsule containing an infusion product which can conveniently use capsules for machines of the household type, although being able to use functions and operational quality of an automatic or semi-automatic machine.

In the scope of this technical task, an object of the invention is to realize a device for perforating a capsule containing an infusion product allowing the user to speed up the loading and cleaning of a traditional filter holder by using, for this purpose, a capsule instead of conventional coffee powder.

It is a further object of the present invention to realize a device for perforating a capsule containing an infusion product which allows this operation outside the coffee machine and which ensure a uniform hole arrangement thereby guaranteeing a perfect passage of hot water inside it.

Is this still an object of the invention to realize a device for perforating a capsule containing an infusion product that is both economic and functional, while ensuring a remarkable effectiveness.

Last but not least object of the invention is to realize a device for perforating a capsule containing an infusion product also able to simply act as a pressure member of the coffee powder laid inside the filter holder in case the capsule is not used.

The above mentioned technical task, as well as these and other objects according to the present invention, are achieved by using a device for perforating a capsule containing an infusion product, characterized by comprising a support of a filter holder for automatic or semi-automatic coffee machines in which said capsule and a perforating element of said capsule contained in the seat of said filter holder are housed, said perforating element having a circular-shaped surface having on a face thereof a plurality of spikes having a maximum reciprocal distance that is smaller than the diameter of the collar of said capsule such as to realize, on the aluminum closing film of the same capsule, a plurality of holes communicating with said infusion product.

The perforating element of said capsule comes without means for feeding water to said capsule containing an infusion product. In fact, the perforating device of said capsule is separate from the standard infusion assembly of the automatic or semiautomatic coffee machine. As seen, the perforating element is provided with a circular surface having spikes projecting therefrom: in a preferred embodiment of the invention, this circular surface is flat or substantially flat and is shaped so as to be usable as a pressing member for coffee powder if coffee powder is used in place of a capsule. For this purpose, the device may comprise a housing disc to house the perforating spikes, or the spikes are short enough to allow the closing film to be perforated and the coffee powder to be compressed.

In other words, the device of the invention can be a compressing member to compress the coffee powder, which is provided with a plurality of spikes for perforating the closing film of a capsule before inserting said capsule into the machine by means of the filter holder that, in turn, houses the capsule itself.

Moreover, other characteristics of the present invention are defined in the claims depending from claim 1.

Other characteristics of the present invention concerning the process for perforating said capsule, are defined in claim 12 and its dependent claims.

### BRIEF DESCRIPTION OF THE DRAWINGS

Further characteristics and advantages of the invention will become more evident from the description of a preferred, but not exclusive, embodiment of the device for perforating a capsule containing an infusion product according to the invention, which is illustrated, by way of non-limiting example only, in the accompanying drawings, in which:

FIG. 1 is a perspective view of the device and the filter holder inside which there is a capsule according to the invention.

FIG. 2 shows the filter holder inserted in the support before perforating the capsule and the perforating kinematic system of the invention partially visible.

FIG. 3 shows the moment in which the capsule according to the invention is perforated.

FIG. 4 is a perspective view of the filter holder on the additional support which is not combined with the device but can rest, for example, on a working surface according to the invention.

FIG. 5 shows the capsule which is completely manually perforated according to the invention.

FIG. 6 is a perspective view of the perforating element according to the invention, and

FIG. 7 is a perspective view of the filter holder without capsule therein and where the sealing gasket according to the invention can be seen.

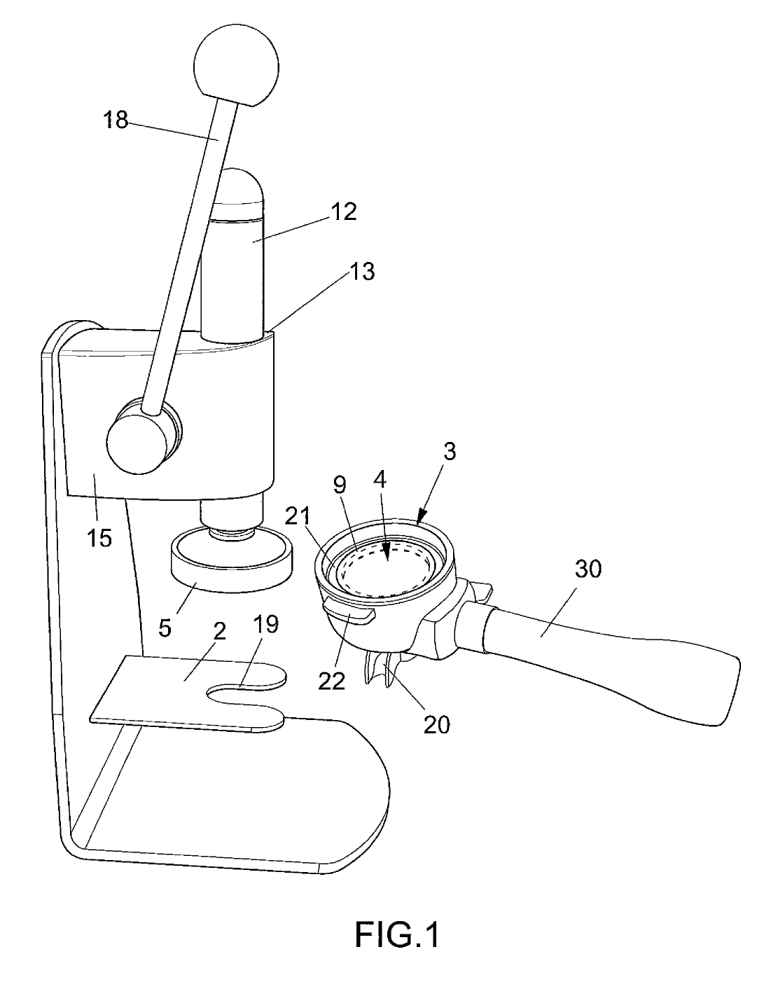

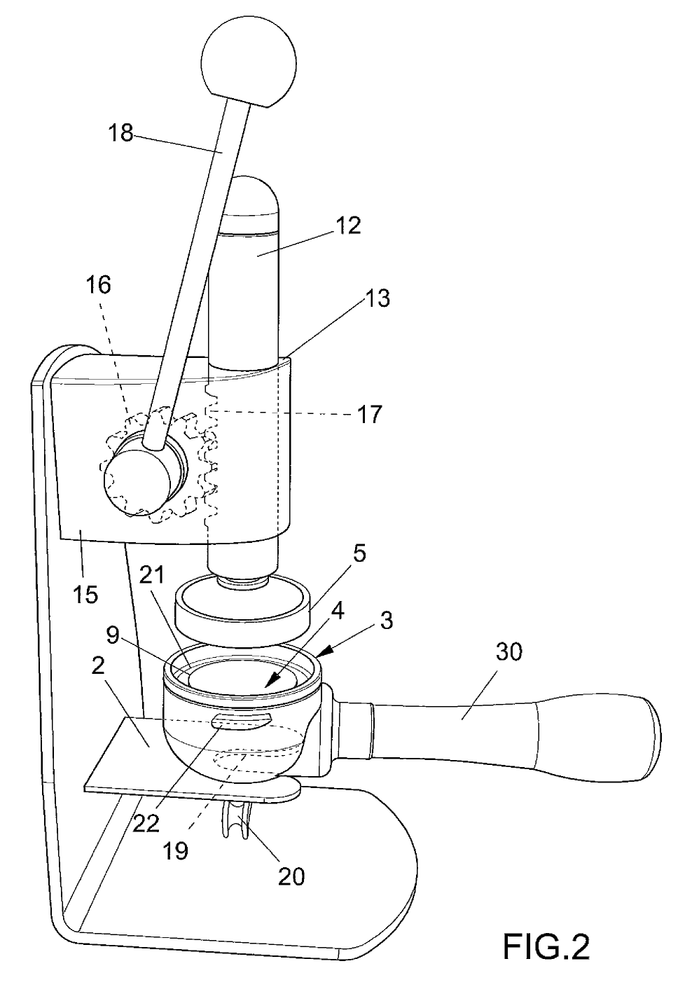

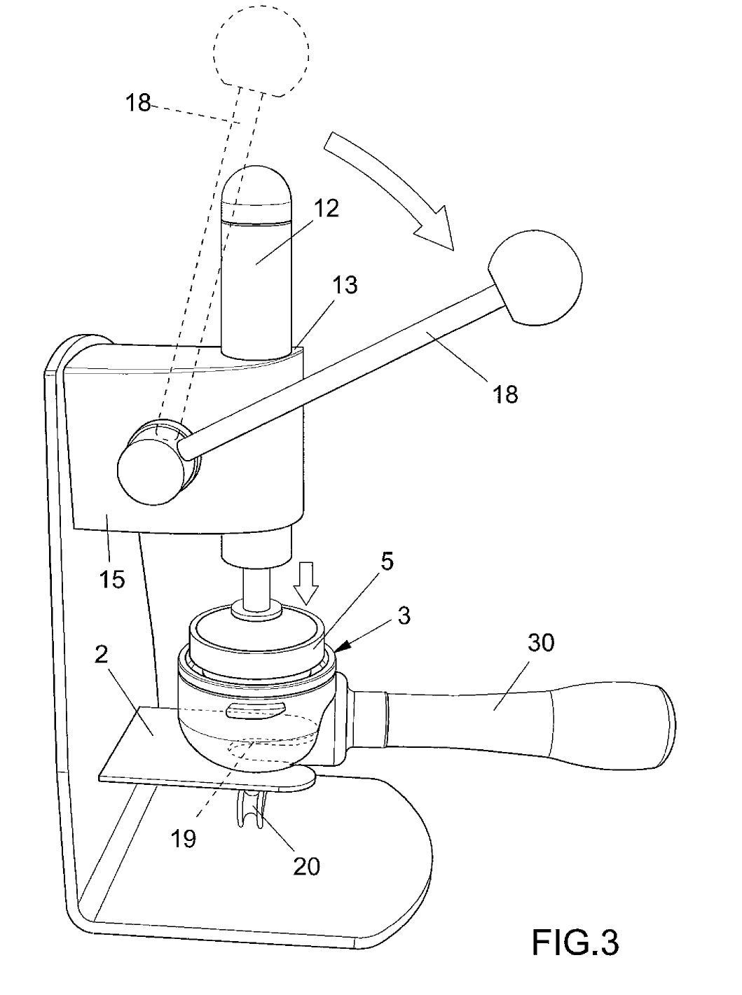

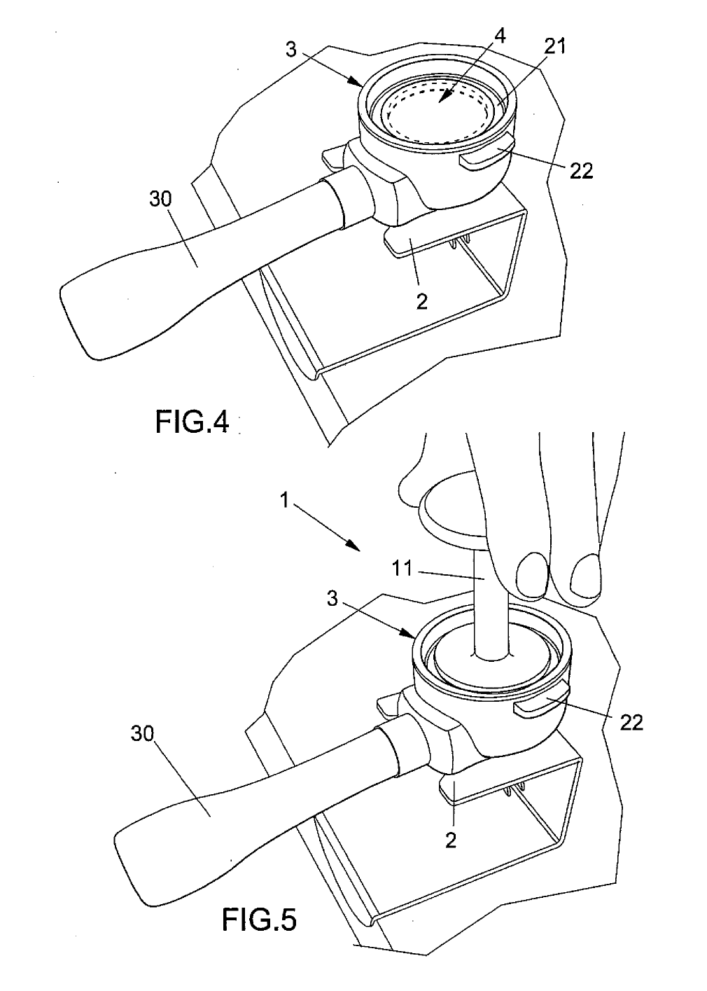

### DETAILED DESCRIPTION OF SOME PREFERRED EMBODIMENTS OF THE PRESENT INVENTION

With particular reference to the above indicated figures, the device for perforating a capsule containing an infusion product, denoted as a whole with the reference number 1, comprises a support 2 of a filter holder 3 for automatic or semiautomatic coffee machines not depicted in the drawings.

Before proceeding it should be specified that, as regards the invention, automatic coffee machine means a machine inside which there is a device for grinding coffee beans in order to transform them in coffee powder to be then automatically introduced in the filter holder where water passes therethrough in order to obtain the coffee-based beverage.

Semiautomatic coffee machine means a machine outside which there is a device for grinding coffee beans in order to transform them in coffee powder to be inserted in the filter holder outside the machine.

When the filter holder is combined with the machine, the water for obtaining the coffee-based beverage is passed therethrough.

A capsule 4, known per se in the art (e.g. of the traditional type), containing a predetermined quantity of coffee powder is housed in the filter holder 3.

However, capsules containing different soluble substances are not excluded from the invention.

The device 1 comprises a perforating element 5 to perforate the capsule 4 contained in the seat 6 of the filter holder 3.

The perforating element 5 has a surface with a circular shape having on the face 7 thereof a plurality of spikes 8 having a maximum reciprocal distance that is smaller than the diameter of the collar 9 of the capsule 4 such as to realize, on the laminated aluminum (or other materials) closing film thereof, a plurality of holes which are not shown and uniformly communicate with said infusion product and. particularly, with the coffee powder. The circular-shaped surface can be adapted to compress the coffee powder, even if there are perforating spikes to perforate the film, providing an additional disc for housing the perforating spikes, if need be.

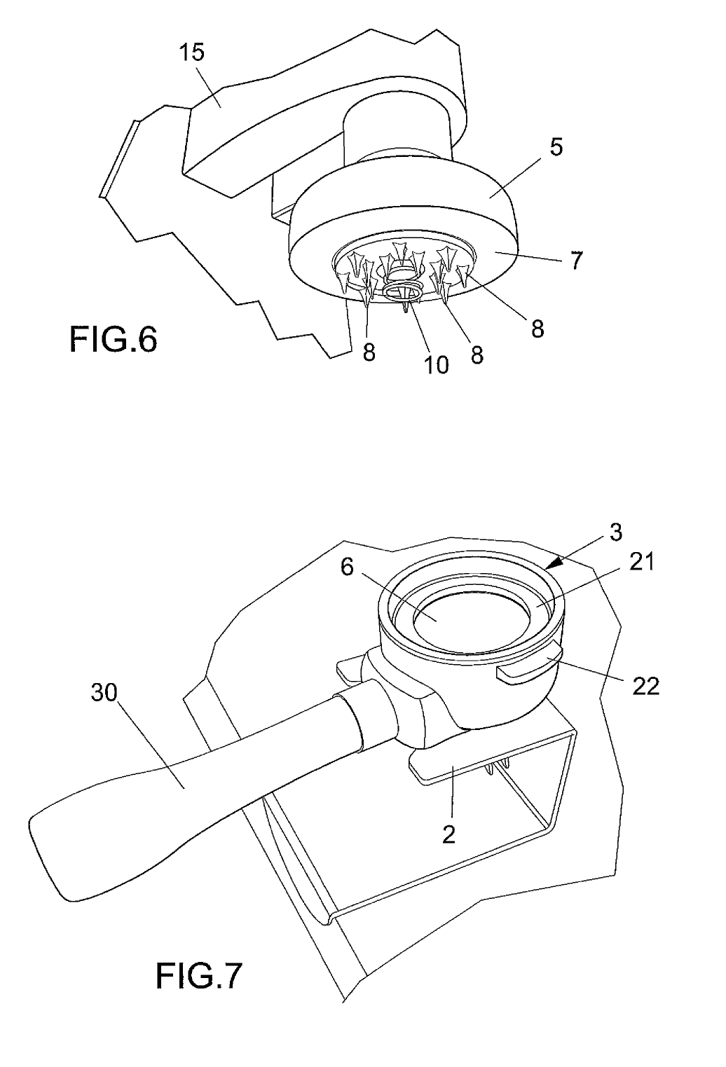

In the embodiment shown in FIG. 6, the face 7 centrally has a spring 10 for detaching the capsule from the spikes 8 when the closing film has been perforated.

In a first low-cost solution, the perforating element 5 has a gripping member 11 able to be manually gripped and pressed against the capsule in order to carry out the perforation thereof.

In this case, the support 2 can be rested on a table or any other support adapted to the operation to be carried out.

In a preferred embodiment, the perforating element 5 is supported by a cylinder 12 sliding internally of a sleeve 13 by means of an activating kinematic system, depicted as a whole by numeral 14, housed in a containing body 15 of the device also having the support 2 as integral part thereof.

More particularly, the activating kinematic system 14 comprises a cogwheel 16 engaging in a rack 17 longitudinally developing on the side of the cylinder 12.

Conveniently, the cogwheel 16 is activated by a lever 18 hinged on the containing body 15 so as to position beforehand the capsule in a position coaxial with the perforating element 5.

In this case, in fact, the filter holder is introduced in the support 2 by means of a recess 19 correctly positioning it under the perforating element 5.

The effort made by the user in order to perforate the capsule is extremely gradual and limited, due to the lever 18.

The filter holder 3 has on below one or more dispensing spouts 20 through which the infusion produced with said automatic or semi-automatic coffee machine is dispensed. Advantageously, a gasket 21 adapted to seal the infusion assembly, not shown, of the coffee machine is arranged in the filter holder 3.

The gasket 21 is arranged below the collar 9 of the capsule 4 so that on the one hand, as seen, its part exceeding the collar allows the perfect seal with the infusion assembly and, on the other hand during the perforation of the capsule, it allows a damping of the collar keeping it elastically supported in an uniform manner so as to guarantee its intact shape and avoid any possible and damaging deformations thereof.

Because the filter holder is of the conventional type, it has a handle 30 and engaging means 22 with said automatic or semi-automatic coffee machine.

In particular, the engaging means 22 combine the filter holder with the infusion assembly by roto-translation or simply by sliding.

Referring to figures and particularly to FIG. 6, the perforating device 1 of the capsule 4 is separate from the standard infusion assembly of automatic or semiautomatic coffee machines, not shown in figures. In particular, the device comprises the perforating elements 5 and the spikes 8 but does not comprise means for feeding water for the infusion of the beverage. The infusion is carried out in the coffee machine, which is known per se in the art.

Advantageously, in a structural variation not depicted in the drawings, the perforating element 5 is provided with an additional perforated disc which can hold the spikes 8 so as to provide a substantially flat surface adapted to allow the coffee powder to be pressed in the filter holder in case of a traditional use without the capsule.

The so-designed device for perforating a capsule containing an infusion product is susceptible of several modifications and variations, all falling within the inventive conception; furthermore, all the details can be replaced by technically equivalent elements.

In practice, any materials or sizes can be used according to the requirements and the state of the art.

1. Device for perforating a capsule containing an infusion product, said capsule having a closing film and a collar, characterized in that it comprises a support of a filter holder for automatic or semi-automatic coffee machines in which said capsule and a perforating element to perforate said capsule contained in a seat of said filter-holder are housed, said perforating element having a surface with a circular shape having on a face thereof a plurality of spikes having a maximum reciprocal distance that is smaller than a diameter of the collar of said capsule such as to realize, on the closing film of the same capsule, a plurality of holes communicating with said infusion product.

2. The device for perforating a capsule containing an infusion product according to claim 1, characterized in that said face centrally has a spring for detaching said capsule from said spikes when said aluminum film has been perforated.

3. The device for perforating a capsule containing an infusion product according to claim 2, characterized in that said perforating element has a gripping member adapted to be manually gripped.

4. The device for perforating a capsule containing an infusion product according to claim 2, characterized in that said perforating element is supported by a cylinder sliding internally of a sleeve by means of an activating kinematic system housed in a containing body said support is combined with.

5. The device for perforating a capsule containing an infusion product according to claim 4, characterized in that said activating kinematic system comprises a cogwheel engaging in a rack developing on said cylinder, said wheel being activated by a lever hinged on said containing body.

6. The device for perforating a capsule containing an infusion product according to claim 1, characterized in that said filter holder has one or more dispensing spouts on below to dispense the infusion produced with said automatic or semi-automatic coffee machine and a sealing gasket to seal with the infusion assembly of said machine.

7. The device for perforating a capsule containing an infusion product according to claim 1, characterized in that said gasket is arranged below said collar of said capsule.

8. The device for perforating a capsule containing an infusion product according to claim 1, characterized in that it has a handle and engaging means to engage said automatic or semi-automatic coffee machine.

9. The device for perforating a capsule containing an infusion product according to claim 8, characterized in that said engaging means combine said filter holder with said infusion assembly by roto-translation.

10. The device for perforating a capsule containing an infusion product according to claim 8, characterized in that said engaging means combine said filter holder with said infusion assembly by sliding.

11. The device for perforating a capsule containing an infusion product according to claim 1, wherein said surface having on its face a plurality of spikes is adapted to compress powdered coffee.

12. Filter holder combinable with an infusion assembly of automatic or semi-automatic coffee machines, said filter holder comprising a seat for a capsule containing an infusion product, said capsule being of the type comprising an upper flange, characterized in that said filter holder comprises a sealing gasket acting on the bottom of the upper flange of the capsule so that a standard infusion assembly for ground coffee can be used without using a further sealing gasket mounted on the infusion assembly.

13. Process for preparing a beverage by an automatic or semi-automatic coffee machine comprising an infusion assembly and a filter holder that is adapted to accommodate a capsule containing an infusion product, said process comprising:
inserting said capsule into said filter holder,
perforating said capsule by means of a device according to claim 1, said device being without means for feeding water to said capsule, and
subsequently engaging said filter holder to said coffee machine.

14. The process according to claim 13, wherein said perforating said capsule by a perforating device is carried out manually through a gripping member adapted to be manually gripped.

15. The process according to claim 13, wherein said perforating said capsule by a perforating device is carried out by means of an activating kinematic system housed in a containing body wherein the perforating element is supported by a cylinder sliding internally of a sleeve.

16. The process according to claim 15, wherein said activating kinematic system is activated by means of a lever hinged on said containing body activating a cogwheel engaging in a rack developing on said cylinder.

17. A process for preparing a beverage by an automatic or semi-automatic coffee machine having an infusion assembly and a filter holder that is adapted to accommodate a capsule containing an infusion product, said process comprising:
inserting said capsule containing an infusion product into said filter holder, said capsule having a closing film and a collar,
perforating said capsule using a device comprising a support of said filter holder, said support housing said capsule and a perforating element for perforating said capsule contained in said filter holder, said perforating element having a surface with a circular shape having on a face thereof a plurality of spikes having a maximum reciprocal distance that is smaller than a diameter of the collar of said capsule such that said perforating creates a plurality of holes in the closing film of said capsule, said plurality of holes communicating with said infusion product, and
subsequently engaging said filter holder to said coffee machine.

18. The process according to claim 17, wherein said perforating is carried out by means of an activating kinematic system housed in a containing body.
